(19) United States
(12) Patent Application Publication
(10) Pub. No.: US 2006/0038480 A1
(43) Pub. Date: Feb. 23, 2006

(54) Flat-panel display apparatus

(76) Inventors: Tetsu Ohishi, Hiratsuka (JP); Yoshie Kodera, Chigasaki (JP); Toshio Tojo, Ichinomiya (JP); Yoshiro Mikami, Hitachiohta (JP); Toshimitsu Watanabe, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/207,944

(22) Filed: Aug. 22, 2005

(30) Foreign Application Priority Data
Aug. 23, 2004 (JP) 2004-241795

(51) Int. Cl. H01J 63/04; H01J 1/62

(52) U.S. Cl. 313/495

(57) ABSTRACT

This invention provides a flat-panel display apparatus adapted to reduce the electric charges stored into fluorescent materials, and to allow spacers to be arranged easily and accurately, and capable of displaying high-quality images by improving color purity of the colored light emitted toward the viewing side. The display apparatus according to this invention has a rear substrate 1 including an electrical insulating substrate 10 on which are formed a large number of cold-cathode elements 19 for emitting electrons, a display substrate 101 including a light-transmissive substrate 110 which is disposed facing the rear substrate 1 and on which are formed the fluorescent materials 111 that emit light when excited by the electron beams sent from the cold-cathode elements 19, and a frame member 116. A metallic sheet 120 in which a large number of fine-structured holes 122 each containing one fluorescent material 111 and for forming a light-emitting region are provided in matrix form is disposed on the light-transmissive substrate 110. Color filters that transmit the rays-of-light of desired colors, emitted from associated fluorescent materials, are provided between the light-transmissive substrate containing the fine-structured holes, and the fluorescent materials.

### CLAIM OF PRIORITY

The present application claims priority from Japanese application serial no. P2004-241795, filed on Aug. 23, 2004, the content of which is hereby incorporated by reference into this application.

### BACKGROUND OF THE INVENTION

(1) Field of the Invention

The present invention relates to flat-panel display apparatus, and more particularly, to a field emission display (hereinafter, referred to as FED) which is a flat-panel display apparatus whose electron source in which a great number of cold-cathode elements for emitting electrons are arranged in matrix form is accommodated in a hermetically sealed container.

(2) Description of the Related Art

As disclosed in, for example, FIG. 21 of Japanese Patent Laid-open No. 2001-101965, an FED is configured such that a rear substrate and a display substrate are opposed to each other. The rear substrate includes an electrical insulating substrate on which the electron emission elements to function as cold-cathode elements are arranged in matrix form. The display substrate includes a light-transmissive substrate on which are provided those fluorescent materials of the three primary colors (R, G, B) that emit light by utilizing collisions of the electrons emitted from the electron emission elements. A frame member is provided at the peripheral section between the above-mentioned rear substrate and display substrate, and then the frame member is sealed with frit glass or the like. The space inside the thus-constructed FED is filled with a vacuum pressure from about 10⁻⁵ to 10⁻⁷ torr. Electrons from the cold-cathode elements mentioned above are accelerated by an acceleration voltage and collide with the fluorescent materials, whereby light is emitted.

The FED also has a support structure (hereinafter, referred to as the spacer) inside the above space in order to prevent the vacuum state from being destroyed by an atmospheric pressure. The spacer is disposed in, for example, the stripe-shaped black matrixes provided between the fluorescent materials so as not to obstruct the orbit of electrons that ranges from the electron emission elements operating as the electron source to the fluorescent materials. The spacer needs to be thinner to obtain higher screen resolution. A known technique for installing a thin spacer is described in, for example, Japanese Patent Laid-open No. 2000-294170. This technique is by providing a recess that matches the shape of the spacer, in the rear substrate and the display substrate, and fitting the spacer into the recess.

### SUMMARY OF THE INVENTION

As mentioned above, since electrons collide with the fluorescent materials, the electrons electrically charge the fluorescent materials. There is a problem in that the charge reduces the light-emitting characteristics of the fluorescent materials with the elapse of time.

Also, a plurality of electron emission elements are arranged in matrix form on the rear substrate and a bus-wiring layer for interconnecting each electron emission element is further formed on this substrate. For these reasons, it is difficult to avoid these regions and provide, in the range of length that is spanned between plural pixels, a recess that matches the shape of the spacer described in Japanese Patent Laid-open No. 2000-294170.

In addition, the acceleration voltage for accelerating the electrons that the cold-cathode elements emit cannot be made too high (the maximum permissible acceleration voltage is about 10 kV). This is because the distance between the rear substrate and the light-transmissive substrate is short (several millimeters) and thus because unusual electrical discharge is liable to occur. That is to say, the acceleration voltage level is appropriately controlled for purposes such as preventing the unusual discharge. The quantity of electrons colliding with the surface of each fluorescent material, therefore, needs to be increased to improve brightness in the FED. The life of the fluorescent material, however, is reduced if electrons collide only with the fluorescent material surface. The life of the fluorescent material is maintained in a trade-off relationship with brightness and color purity, and extending the life tends to deteriorate color purity of the colors developed by the fluorescent material. This results in a problem in that a color reproduction range is narrowed and hence image quality decreases.

The present invention has been made in view of the above problems, and an object of the invention is to provide a flat-panel display apparatus that can display high-quality images by, while at the same time lessening the amount of electrical charging of fluorescent materials, improving color purity of the colored light emitted to the viewing side. The present invention also provides a flat-panel display apparatus that permits spacers to be arranged easily and efficiently while at the same lessening the amount of electrical charging of fluorescent materials.

In the present invention, a conductive sheet-like member with a plurality of holes formed in matrix form is disposed on the side of a light-transmissive substrate of a display substrate that faces a rear substrate, a plurality of holes with fluorescent materials existing in the sheet-like member are provided, and a color filter is provided between the fluorescent material within each of the latter holes and the light-transmissive substrate. Instead of the above-mentioned color filter being provided nearby, the fluorescent material may be impregnated with a dye or pigment for transmitting a desired color of the light emitted. The color filter or the above-mentioned dye or pigment may be able to transmit at least one kind of colored light of all light emitted by the fluorescent materials.

The above-mentioned sheet-like member is conductive and each fine-structured hole with a specific fluorescent material existing therein and forming a light-emitting region (in other words, pixel) has a conductive wall surface. Accordingly, a stored electric charge within the fluorescent material is transmitted to the sheet-like member side, thus making it possible to reduce electrical charging of the fluorescent material. Additionally, the present invention having such a color filter or dye or pigment as mentioned can improve color purity of the colored light emitted to the viewing side.

A pinning layer composed mainly of a material of a low fusion point, such as glass, silica, ceramic, or alumina, may be used to fasten the sheet-like member to the light-transmissive substrate. This pinning layer may have approximately the same thermal expansion coefficient as that of such metallic sheet as mentioned above, or of the light-transmissive substrate. Constructing the sheet-like member in this way makes it possible to lessen the impacts of the thermal strain occurring between these constituent elements.

Also, the above sheet-like member may be constructed of, for example, an alloy whose principal component is Fe—Ni, and the side of this member that faces the light-transmissive substrate may be formed in black as a black-matrix layer for improving contrast. Spacers can thus be assembled accurately and easily without reducing contrast.

In addition, in the present invention, recesses for holding the spacers that maintain a spatial interval between the rear substrate and the display substrate are formed in the sheet-like member. Thus, the above-mentioned spacers can be easily positioned while at the same time reducing the amount of electrical charging of the fluorescent materials.

According to the present invention, it is possible to improve color purity of the colored light emitted to the viewing side, while at the same time lessening the amount of electrical charging of fluorescent materials. It is also possible to arrange spacers easily and efficiently.

### BRIEF DESCRIPTION OF THE DRAWINGS

FIG. 1 is a schematic configuration diagram of a flat-panel display apparatus, showing an embodiment of the present invention;

FIG. 2 is a detailed view showing section A of FIG. 1 in enlarged form;

FIG. 3A is a top view of a metallic sheet;

FIG. 3B is a view showing a shape of a fine-structured hole provided in a metallic sheet;

FIG. 3C is a view showing a shape of a fine-structured hole provided in a metallic sheet;

FIG. 3D is a view showing a shape of a fine-structured hole provided in a metallic sheet;

FIG. 4A is a top view of a metallic sheet provided with recesses by way of example;

FIG. 4B is a top views of a metallic sheet provided with recesses by way of another example;

FIG. 5A is a top view of a metallic sheet provided with recesses by way of another example;

FIG. 5B is a top views of a metallic sheet provided with recesses by way of another example; and

FIG. 6 is a partially enlarged view of a flat-panel display apparatus, showing another embodiment of the present invention.

### DETAILED DESCRIPTION OF THE PREFERRED EMBODIMENTS

Embodiments of the present invention will be described hereunder referring to the accompanying drawings.

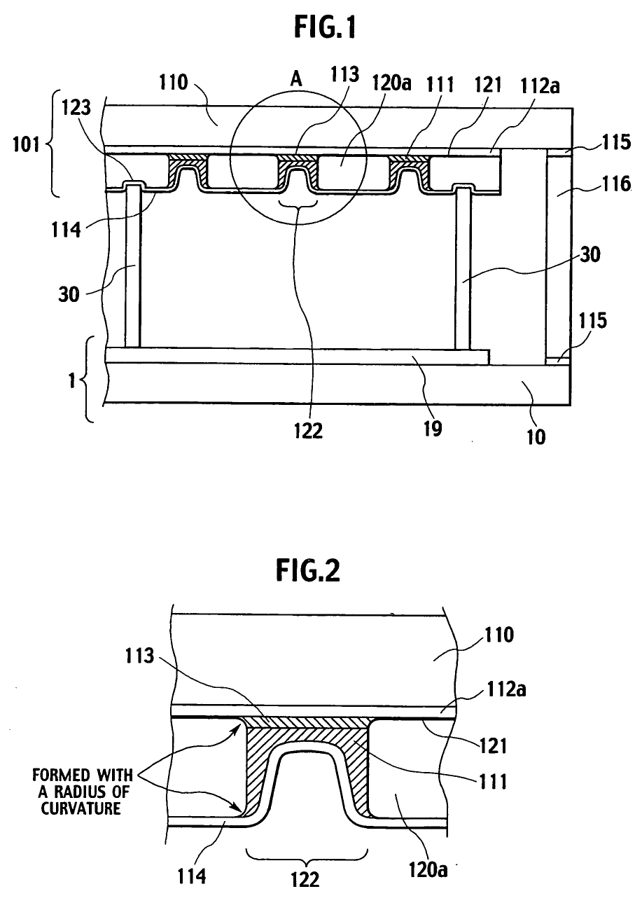

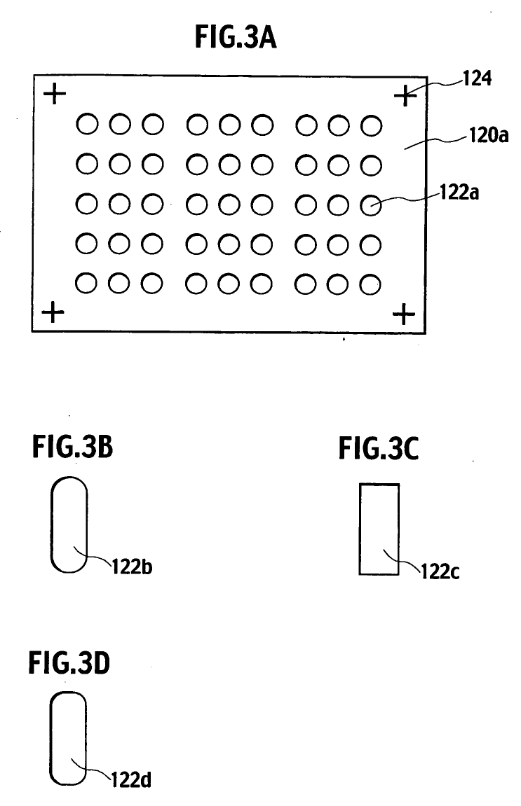

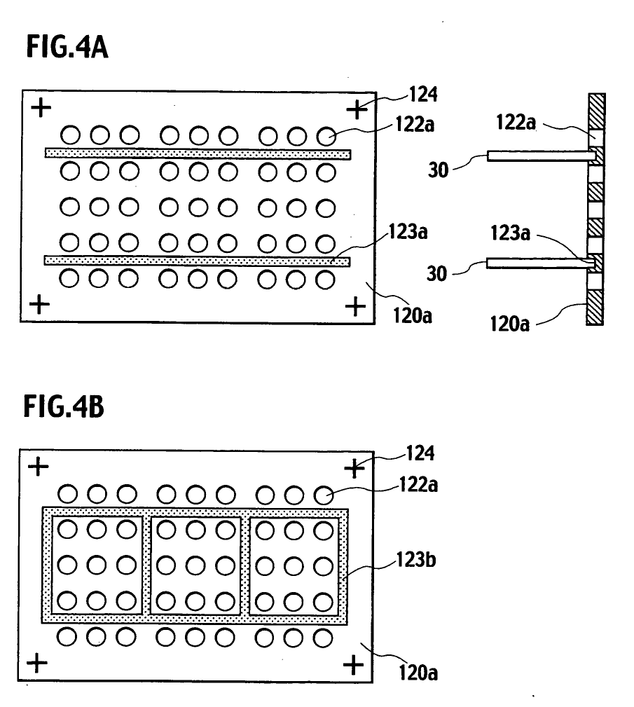

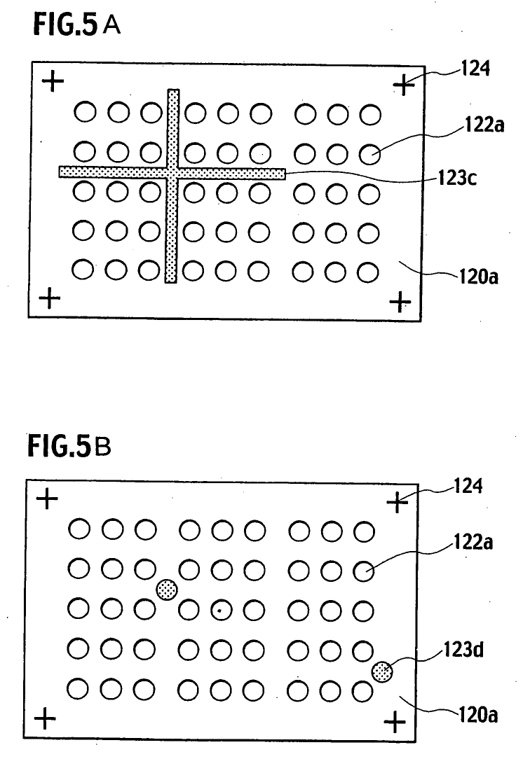

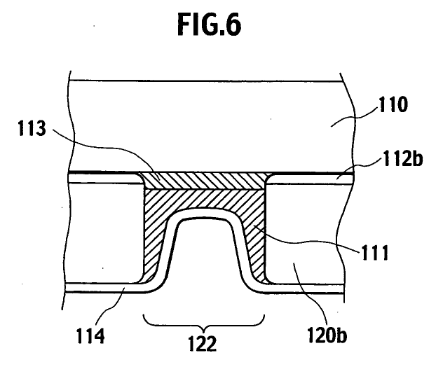

Embodiments of a flat-panel display apparatus according to the present invention are described in detail below using FIGS. 1 to 6. FIG. 1 is a schematic configuration diagram of a flat-panel display apparatus, showing an embodiment of the present invention. FIG. 2 is a detailed view showing section A of FIG. 1 in enlarged form. FIG. 3A is a top view of a sheet-like member according to the present invention (in the present embodiment, the sheet-like member is composed of a metal and is therefore called the metallic sheet); FIG. 3B is a view showing a shape of a fine-structured hole provided in a metallic sheet; FIG. 3C is a view showing a shape of a fine-structured hole provided in a metallic sheet; and FIG. 3D is a view showing a shape of a fine-structured hole provided in a metallic sheet. FIGS. 4A and 4B are top views each showing an example of a metallic sheet provided with recesses. FIGS. 5A and 5B are top views each showing another example of a metallic sheet provided with recesses. FIG. 6 is a partially enlarged view of a flat-panel display apparatus, showing another embodiment of the present invention. In all figures, the same reference number is assigned to sections common to each figure, and these common sections are not repeatedly described.

Flat-panel display apparatus of the present invention has: a rear substrate including an electrical insulating substrate on which are formed a plurality of cold-cathode elements each for emitting electrons; a display substrate including a light-transmissive substrate disposed facing the rear substrate, wherein fluorescent materials that emit light when excited by the electron beams sent from the cold-cathode elements are formed on the light-transmissive substrate; and a frame member.

A space defined by the rear substrate, the display substrate and the frame member is maintained in a vacuum atmosphere. The display substrate is characterized by having a conductive metallic sheet in which a plurality of holes each containing a fluorescent material and forming a light-emitting region are provided in matrix form (hereinafter, these holes are called the fine-structured holes). This metallic sheet is provided on a light-transmissive substrate of the display substrate.

### First Embodiment

A first embodiment of the present invention is described below. FIG. 1 is a schematic configuration diagram of a flat-panel display apparatus, showing an embodiment of the present invention. In FIG. 1, a display substrate 101 includes: a light-transmissive substrate 110 formed of light-transmitting glass or the like; a thin metallic sheet 120a with a large number of fine-structured holes 122 arrayed in matrix form (two-dimensional form); a pinning layer 112a of a low fusion point, formed to fasten the metallic sheet 120a to the light-transmissive substrate 110; a color filter 113 and a fluorescent material 111, both contained in a coated condition inside each fine-structured hole 122 of the metallic sheet 120a, and a metal backing 114 of the aluminum (Al) formed by, for example, chemical vapor deposition.

The large number of fine-structured holes 122 formed in matrix form in the metallic sheet 120a, as in the shadow mask used for a cathode-ray tube (CRT), are used as holes for coating with the color filter 113 and with the fluorescent material 111. Also, the side of the metallic sheet that faces the light-transmissive substrate 110 has an approximately black surface functioning as a region of black matrixes 121 to prevent reflection of external light and hence, decrease in contrast. In addition, a recess 123 with a dent or groove (or the like) for inserting a spacer 30 is provided on the side of the metallic sheet 120a that faces the rear substrate 1.

The rear substrate 1 includes an electrical insulating substrate 10 made of, for example, glass or the like, and a cold-cathode electron emission element forming layer 19 operating as an electron source formed by a great number of electron emission elements on the insulating substrate 10.

The flat-panel display apparatus has its display substrate 101 and its rear substrate 1 supported by spacers 30, uses frit glass 115 to seal with a frame 116 a periphery of the display substrate 101 and that of the rear substrate 1, and is internally maintained in a hermetic state at a vacuum pressure from about 10⁻⁵ to 10⁻⁷ torr.

The metallic sheet 120a, an ultralow-carbon-content thin steel plate of an Fe—Ni alloy, has a large number of fine-structured holes 122 formed in matrix form in this steel plate by etching. After this, the surface of the steel plate is blackened by being subjected to heat treatment for 10 to 20 minutes in an oxidizing atmosphere at a temperature from 450 to 470° C. below a recrystallizing temperature of steel. This manufacturing method is the same as that of the shadow mask used as a color selection mask for desired fluorescent materials to be irradiated with electron beams in the CRT for a color TV. Equipment for manufacturing a conventional shadow mask, therefore, can be used intact to manufacture the metallic sheet.

A sheet with a plate thickness from 20 to 250 μm is used as the metallic sheet. The plate thickness has its upper limit set to 20 μm because steel plates thinner than this value are in lean commercial demand and because, as described later herein, layers of the fluorescent materials 111 are thin (approximately 5 to 20 μm). Also, thickness of a layer of each color filter 113 is set to range from approximately 0.5 to 10 μm, in consideration of the amount of transmission, color purity, and other factors of the light transmitted. A lower limit of the plate thickness, therefore, is preferably greater than the thickness of the layer of the color filter 113. Further preferably, the upper limit of the plate thickness is 250 μm or less in terms of price and because Fe—Ni alloyed expensive ultralow-carbon-content thin steel plates exceeding 250 μm are in lean commercial demand.

The fluorescent material 111 existing in a fine-structured hole 122 is excited by the electron beams emitted from an electron emission element of the rear substrate 1. The secondary electrons generated by an excited fluorescent material 113 could leak into adjacent fine-structured holes 122, exciting the internally existing respective fluorescent materials 111, and causing the fluorescent materials to emit light. However, if height of each fine-structured hole 122 and the thickness of the metallic sheet are increased above the thicknesses of the layers of each fluorescent material 111 and of each color filter 113, the secondary electrons generated will be absorbed by an inner wall of the fine-structured hole 122 (since, as described later herein, the inner wall will have its black oxidizing film removed and the inner wall surface itself has electroconductivity). The secondary electrons will also be absorbed by the metal backing 114. In short, it is possible, by giving the metallic sheet the thickness that satisfies the above, to prevent secondary electrons from any fluorescent materials 111 from leaking into adjacent fine-structured holes 122. According to the present embodiment, therefore, the amount of electricity stored into each fluorescent material can be lessened.

Since the metallic sheet 120a is an electrically insulating black oxidizing film formed by surface blackening, the face of this sheet that is directed toward the light-transmissive substrate 110 can be used as a region of black matrixes 121. However, the electrically insulating black oxidizing films formed on an inner surface of each fine-structured hole 122 and on the face of the metallic sheet 120a that is directed toward the rear substrate 1 are removed by, e.g., sandblasting. This is conducted to remove the stored electricity from the fluorescent material and to assign electroconductivity with respect to the metal backing. Thus, the inner surface of the fine-structured hole 122 and the face directed toward the rear substrate 1 conduct electricity.

The thus-treated metallic sheet 120a is fastened to the light-transmissive substrate 110 via a pinning layer 112a of a low fusion point (500° C. or less). For example, frit glass which is glass of a low fusion point is used as a fastening member of the pinning layer 112a. The metallic sheet 120a is bonded by coating the light-transmissive substrate 110 with the frit glass, then heat-treated at 450 to 470° C., and sintered. Polysilazane, a liquid glass precursor, is available as another fastening member, which may be used to fasten the metallic sheet 120a by sintering at a temperature of at least 120° C.

Optical characteristics of the pinning layer are not limited to transparency only. For CRTs, for example, glass whose light-transmitting property is limited only to a desired level is traditionally applied to front-panel materials in order to improve contrast. Similarly to CRTs, the present invention also gives a contrast performance improvement effect by adopting a transparent light-transmissive substrate and constructing the above-mentioned pinning layer as a glass layer whose light-transmitting property is limited only to a desired level. Since glass layers of this kind are traditionally constructed for CRT use, the glass layer in the present embodiment may also be formed using a method equivalent to such a conventional method.

The metallic sheet 120a is fastened to the light-transmissive substrate 110 via the pinning layer 112a. It is desirable that to reduce thermal strain due to a difference from the light-transmissive substrate 110, the metallic sheet 120a should have a thermal expansion coefficient approximately equal to that of the light-transmissive substrate 110. When glass is used as the light-transmissive substrate 110, the glass is about 38-90×10⁻⁷/° C. (at 30 to 300° C.) in thermal expansion coefficient. The thermal expansion coefficient of the metallic sheet 120a, an alloy composed mainly of Fe and Ni, can be made to approximately equal the thermal expansion coefficient of the above glass, by changing nickel (Ni) in content. For example, if borosilicate glass with a thermal expansion coefficient of 48×10⁻⁷/° C. is used as the light-transmissive substrate 110, a thermal expansion coefficient approximately equal to that of the borosilicate glass is obtainable by employing an Fe—42% Ni alloy as a material of the metallic sheet 120a.

From the same viewpoint, it is desirable that the pinning layer and the color filters should also have a thermal expansion coefficient approximately equal to that of the light-transmissive substrate 110. Accordingly, as described above, frit glass, for example, that has a thermal expansion coefficient approximately equal to that of the light-transmissive substrate 110 formed of a glass material is used as the fastening member.

Although it is desirable that the metallic sheet 120a should have a thermal expansion coefficient approximately equal to that of the light-transmissive substrate 110, the glass-formed light-transmissive substrate 110 and the pinning layer are weak against tensile stresses. For this reason, the thermal expansion coefficient of the metallic sheet 120a may be increased slightly above the thermal expansion coefficient of the light-transmissive substrate 110 and/or that of the pinning layer 112a. Also, the light-transmissive substrate and the pinning layer may be constructed so as to be resistant to compressive stresses during actual operation.

According to the embodiment described above, the metallic sheet has a large number of fine-structured holes beforehand and is subjected to surface blackening before the sheet is fastened to the light-transmissive substrate via the pinning layer. Formation of the metallic sheet according to the present invention, and the fastening of this sheet to the light-transmissive substrate are not limited to such a process. For example, a metallic sheet that has undergone surface blackening beforehand by heat treatment in an oxidizing atmosphere may be fastened to the light-transmissive substrate via the pinning layer and then a large number of fine-structured holes may be formed on the surface of that metallic sheet by etching. Using this process not only assigns a function equivalent to that of the above-described embodiment, but also offers an advantageous effect that since the metallic sheet has no fine-structured holes when fastened to the light-transmissive substrate, the metallic sheet can be easily handled and its fastening efficiency improves.

The dye or pigment having the same color as that principally of desired colored light (colored light to be transmitted) is mixed with acrylic resin, a solvent, silica, or the like, in order to construct the color filter. To transmit red light, for example, a red color filter is obtainable by coating the surface of the light-transmissive substrate 110 with any such material (e.g., acrylic resin) pre-mixed with a pigment which contains iron oxide, then subjecting the coated surface to heat treatment at 400 to 500° C., and sintering the coated surface. This process can also be applied to other colors. Cobalt-containing pigments and other various pigments are available to give a blue color, for example. It is necessary, however, to select a pigment or any other appropriate coating material whose heat-resisting temperature is high enough to prevent deterioration at a forming temperature for the fluorescent material. A relationship between colored light and wavelength needs to be established so that as in a general case, blue, green, and red at least include a wavelength of about 450 nm, about 520 nm, and about 630 nm, respectively.

As described above, after the metallic sheet 120a has been fastened to the light-transmissive substrate 110 via the pinning layer 112a that is a glass layer, the fine-structured holes 122 are each formed by being coated with a color filter 113 of red (R), green (G), or blue (B). Subsequently, fluorescent materials 111 of colors associated with the colors of the color filters 113 are each formed by being coated with to a thickness from about 10 to 20 μm. Next after the surface of each fluorescent material 111 has been treated with a filming material, the metal backing 114 constructed of aluminum, for example, is formed with a thickness from about 30 to 200 nm by vacuum vapor deposition. The metal backing 114 removes charged electricity from the fluorescent material 111 and reflects to a front panel the light emitted from the fluorescent material 111. The metal backing 114 also operates as an electrode that applies an acceleration voltage for accelerating the electrons emitted from the electron emission elements. Of course, there is a need to allow sufficient passage of these electrons. In terms of this, the metal backing has its thickness set to stay within the above range. A thickness of approximately 70 nm is preferred.

The color filter, the fluorescent material, and the filming material have their densities adjusted by impregnating each with resin or a solvent in order to obtain the viscosity that facilitates formation. For example, the fluorescent material is adjusted to a density from approximately 10% to 90% and the color filter is adjusted to a density from approximately 1% to 10%. In general, when a film is formed, reducing viscosity makes coating easier, whereas the problem occurs in that a desired shape cannot be obtained as a result. In particular for the color filter used in the present invention, the desired shape cannot be easily obtained because of low viscosity. In the present invention, however, desired patterns can be formed at desired pitches accurately and easily since applying an appropriate quantity of color filter material dripwise to the surfaces of the fine-structured holes in the metallic sheet spreads the filter material into a desired shape.

Also, although a display substrate usually needs to have its color filters, its fluorescent materials, and its filming material overlapped accurately in openings of the black matrixes, these elements in the present invention need only to be sequentially formed in the fine-structured holes of the metallic sheet. Therefore, the present invention has the effect that these elements can be accurately and easily overlapped for formation.

FIG. 2 is a detailed view showing section A of FIG. 1 in enlarged form. More specifically, an example of a cross section of a fine-structured hole 122 in the metallic sheet 120a is shown in enlarged form in FIG. 2. In the example of FIG. 2, corners of the fine-structured hole 122 are formed into a round shape (i.e., a radius of curvature, R, is created at the corners) on the side facing the light-transmissive substrate 110 and on the opposite side facing the rear substrate. Thus, since angularity is removed from the corners of each fine-structured hole 122, concentration of an electric field at the corners is prevented and electrical discharge becomes less prone to occur. In addition, as mentioned earlier, the electrically insulating black oxidizing films on the inner surface of each fine-structured hole 122 and on the face of the metallic sheet 120a that is directed toward the rear substrate 1 are removed by, e.g., sandblasting. This bestows electroconductivity on those sections. Accordingly, the charge that has been stored into the fluorescent material 111 and the secondary electrons that have been generated by the fluorescent material 111 move to the metallic sheet 120a and the metal backing 114, so it becomes possible to prevent electrical charging of the fluorescent material 111.

Furthermore, the thickness of the metallic sheet 120a is at least 20 μm, which is greater than that of the layer of the fluorescent material 111, and very small depressions and projections are formed on the inner surface of the fine-structured hole 122 by sandblasting. These depressions and projections are effective in that they allow the metal backing 114 to be formed properly, even inside the fine-structured hole 122, in that they do not permit the metal backing to peel off, and thus in that they improve adhesion of the backing.

FIGS. 3A is a top view of the metallic sheet. In FIG. 3A, the metallic sheet 120a has a large number of fine-structured holes 122 provided in matrix form (two-dimensional form). The fluorescent materials with which the fine-structured holes 122 are internally precoated emit light, which then passes through the color filters 113 and form the pixels that provide desired appropriate color purity. FIG. 3A shows an example in which the fine-structured holes 122 are circular ones 122a. Since the fine-structured holes 122 are internally coated with the fluorescent materials, a shape of the pixels agrees with that of the fine-structured holes 122. However, the shape of the pixels, that is, the shape of the fine-structured holes 122, is not limited to circularity. This is the same as for CRTs. The holes can have, for example, an elliptic shape as in FIG. 3B, a rectangular shape as in FIG. 3C, or a rectangular shape with round corners (corners formed to have R) as in FIG. 3D. Reference number 124 in FIG. 3 is an alignment mark, which will be detailed later herein.

In the present embodiment, as shown in FIG. 1, the metallic sheet 120a has a plurality of recesses 123 on a face opposite to that on which the black matrixes 121 are provided. When viewed from a direction of the light-transmissive substrate 110, the recesses 123 exist internally to a region of the black matrixes 121. Accordingly, there is no fear that inserting a spacer 30 into the recesses will or may affect a path of the electron beams coming in from the rear substrate 11 and leading to the fluorescent materials 111. The present invention assumes that the recesses 123 have a depth of 10-125 μm, which is approximately half the thickness of the metallic sheet.

FIGS. 4A, 4B, 5A and 5B show other examples of a metallic sheet. The metallic sheets shown in FIGS. 4A through 5B are provided with recesses for arranging spacers 30, on opposite sides of a region of the black matrixes (equivalent to pixels) that exist between the circular fine-structured holes shown in FIG. 3A. In these examples, a screen pattern size of five lines by three pixels (three-color-pixel construction in which one pixel emits R-light, G-light, or B-light) is assumed for simplicity of graphical representation. In actuality, however, a large number of recesses 123 for arranging great enough a number of spacers for the metallic sheet to withstand atmospheric pressures are, of course, provided in the entire sheet.

In FIGS. 4A through 5B, the recesses 123 are each adapted to accommodate a spacer 30, so spacers 30 can be easily assembled. Accuracy of arranging the spacers 30 is determined by forming accuracy of the recesses 123. However, since the recesses, as with the fine-structured holes, are formed by etching and can thus be formed accurately, the spacers 30 can be arranged at desired positions accurately with respect to the rear substrate 1. Also, metallic sheet 120a is inscribed with, for example, a crosshair alignment mark 124 at four corners by etching, as with the fine-structured holes 122. Usually, cost reduction is possible by conducting the assembly of the spacers 30 automatically using a micromachine. In the above examples, however, there is an advantageous effect that since the alignment marks 124 are used as positioning markers, automatic arrangement of the spacers,30 becomes easy. While alignment marks 124 are provided at four corners in these examples, the present invention is not limited to this arrangement form and it goes without saying that the alignment marks may be provided in a crisscross format. Of course, each recess 123 has a shape analogous to that of an edge of the spacer 30 inserted into the recess.

FIG. 4A shows an example of the recesses provided to arrange flat-plate-shaped spacers in a horizontal direction of the drawing. Rectangular recesses 123a are provided in the horizontal direction of the drawing in order to arrange flat-plate-shaped spacers 30. A plurality of spacers are required for the metallic sheet to withstand the atmospheric pressure applied to the flat-panel display apparatus. Accordingly, a plurality of recesses 123a for spacer insertion are also provided. Needless to say, recesses may be provided in a vertical direction of the drawing.

In FIG. 4B, recesses 123b are provided in ladder form. Spacers (not shown) that are associated with the recesses 123b are of a ladder-shaped structure with a plurality of mutually parallel flat plates combined at right angles between two other parallel flat plates opposed to each other. Support force of the ladder-shaped structure is stronger than that obtained in FIG. 4A.

In FIG. 5A, recesses 123c of a crosshair shape are provided in both vertical and horizontal directions of the drawing. Spacers (not shown) that are associated with the recesses 123c are a crosshair combination of two orthogonal flat plates. In FIG. 5A, the crosshair-shaped recesses 123c are only shown on part of the drawing. In actuality, however, recesses 123c for arranging large enough a number of spacers for the metallic sheet to withstand atmospheric pressures are, of course, provided in the entire sheet.

In FIG. 5B, cylindrical recesses 123d are provided for arranging circular spacers (not shown). Of course, instead of being cylindrical ones (not shown), the spacers in FIG. 5B can be elliptic ones (not shown) that are longer in a horizontal or vertical direction of the drawing. In the latter case, recesses take a cylindrical shape. Also, the spacers can take a shape of a rectangular prism or of a rectangular prism with R assigned by removing corners. In these cases, recesses take a rectangular shape or a rectangular shape having R assigned thereto.

As described above, according to the present invention, a large number of fine-structured holes are formed on the surface of a thin metallic sheet, then these fine-structured holes are internally coated with color filters and with fluorescent materials, and the face of the metallic sheet that has a black oxidizing film formed thereon is used as a black-matrix region for improving contrast. Also, providing a plurality of recesses on the other face of the metallic sheet and then arranging spacers in an inserted condition in these recesses makes it possible to assemble the spacers accurately and easily, without reducing contrast. In addition, since color filters can be easily provided, high-quality images can be displayed by arbitrarily controlling a band and transmittance of the light transmitted from the color filters, and thus improving color purity of the colored light emitted toward the viewing side.

In the above-described embodiment of the present invention, the light-transmissive substrate 110 is coated with a fastening member when the metallic sheet 120a that has been surface-blackened using an ultralow-carbon-content thin steel plate of a Fe—Ni alloy is fastened to the light-transmissive substrate 110. However, the present invention is not limited to this embodiment. For example, a metallic sheet 120b not subjected to surface blackening may be coated with the black-colored fastening member that contains a black pigment, and then fastened to the light-transmissive substrate 110. FIG. 6 is a partially enlarged view of a flat-panel display apparatus, showing another embodiment of the present invention. In FIG. 6, fine-structured holes 122 are provided in the non-blackened metallic sheet 120b. Angularity is removed from the corners of the inner wall of each fine-structured hole 122. Thus, concentration of an electric field at the corners is prevented and electrical discharge becomes less prone to occur. In addition, as mentioned earlier, since neither the inner surface of the fine-structured hole 122 nor the side of the metallic sheet 120b that faces the rear substrate is subjected to blackening, the charge that has been stored into each fluorescent material 111 and the secondary electrons that have been generated by the fluorescent material 111 move to the metallic sheet 120b and the metal backing 114. This prevents electrical charging of the fluorescent material 111. The metallic sheet 120b is fastened to the light-transmissive substrate 110 via a pinning layer 112b, at which time, black matrixes 121 are also formed at the same time.

For example, the frit glass obtained by mixing a black dye or pigment in glass of a low fusion point is used as the fastening member of the pinning layer 112b. In this case, the metallic sheet 120b is bonded by coating the light-transmissive substrate 110 with the frit glass, then heat-treated at 450 to 470° C., and sintered. A heat-resistant adhesive that contains a black pigment and is composed mainly of silica, ceramic, alumina, or the like, is usable as an alternative fastening member, which may be used to sinter the metallic sheet at a temperature of 120° C. or more and conduct the above fastening process.

If the adhesive seeps in a direction of the fine-structured holes, however, the adhesive that has seeped needs to be removed by sandblasting, for example. After this, color filters 113, fluorescent materials 111, and a metal backing 114 are formed in order.

Using the above method makes it unnecessary to subject the metallic sheet to blackening. The use of the above method also makes it possible to omit the process of removing the black oxidizing films from the inner wall of each fine-structured hole 122 and from the other face on which the metal backing is to be formed.

Since it is thin and has porosity, the metallic sheet with the fine-structured holes could bend because of its own weight during handling. Accordingly, the metallic sheet is fastened intact to the light-transmissive substrate using the foregoing heat-resistant adhesive, and then fine-structured holes and others are formed in matrix form by etching. In these process steps, it is possible to prevent bending of the metallic sheet during handling when the metallic sheet is fastened to the light-transmissive substrate. After the formation of the fine-structured holes, however, the fastening agent requires removal by etching or sandblasting.

Also, while the number of kinds of colored light which the color filters are to transmit is basically the same as the number of colors of the fluorescent materials, the present invention is not limited to this configuration. For example, color filters of the following construction may be used for the red (R) and green (G) fluorescent materials whose mutual color mixing is required to be minimized. That is to say, in order for the color filters to transmit both red (R) light of a desired wavelength and green (G) light of a desired wavelength, light-transmitting characteristics of these color filters are set so that they transmit the two kinds of light having wavelengths of at least 520 nm and 630 nm. Doing in this way makes it possible to remove any unnecessary colors included in each fluorescent material, and thus to obtain desired color purity. In this case, simultaneous coating with the color filters for the red and green fluorescent materials is possible and this yields the advantageous effect that manufacture is facilitated. In that case, for the remaining blue B fluorescent material, a color filter needs only to be provided as necessary, and when brightness is required, there is no need to provide a color filter.

As can be seen from the above, one kind of color filter applicable to both red and green needs only to be provided for color filtering. Alternatively, two kinds of color filters, inclusive of a blue color filter, may be provided. Three kinds of color filters, each for red, green, or blue, may otherwise be provided. In any of the above cases, if each color filter is set so as to transmit the light of a desired color that an associated fluorescent material emits, color purity of the colored light emitted toward the viewing side can be improved and high-quality images can be displayed.

Also, although the color filter is provided between a fluorescent material and a transparent substrate, equivalent effects can be obtained by coating with a fluorescent material premixed with a dye and a pigment. In addition, equivalent effects can, of course, be obtained by coating, as appropriate, with a mixture of a dye and a pigment so that as in the above-described embodiment, the color filters transmit both kinds of colored light of desired wavelengths, emitted from at least two kinds of fluorescent materials.

What is claimed is:

1. A flat-panel display apparatus, comprising:
a rear substrate including an electrical insulating substrate on which a plurality of cold-cathode elements each for emitting electrons are formed;
a display substrate including a light-transmissive substrate disposed facing said rear substrate, wherein fluorescent materials that emit light when excited by the electron beams sent from the cold-cathode elements are formed on the light-transmissive substrate; and
a frame member;
wherein:
a space defined by said rear substrate, said display substrate and said frame member is maintained in a vacuum atmosphere;
said display substrate has a conductive sheet-like member disposed on a side of the light-transmissive substrate of said display substrate which faces said rear substrate, the sheet-like member having a plurality of holes formed therein;
the fluorescent materials are provided in the plurality of holes formed in the sheet-like member; and
a color filter is provided between the fluorescent material in each of the holes, and the light-transmissive substrate.

2. A flat-panel display apparatus, comprising:
a rear substrate including an electrical insulating substrate on which a plurality of cold-cathode elements each for emitting electrons are formed;
a display substrate including a light-transmissive substrate disposed facing said rear substrate, wherein fluorescent materials that emit light when excited by the electron beams sent from the cold-cathode elements are formed on the light-transmissive substrate; and
a frame member;
wherein:
a space defined by said rear substrate, said display substrate and said frame member is maintained in a vacuum atmosphere;
said display substrate has a conductive sheet-like member disposed on a side of the light-transmissive substrate of said display substrate which faces said rear substrate, the sheet-like member having a plurality of holes formed therein;
the fluorescent materials are provided in the plurality of holes formed in the sheet-like member; and
the fluorescent material in each of the holes contains a dye or pigment that transmits the light of a desired color, emitted from the fluorescent material.

3. The flat-panel display apparatus according to claim 1, wherein said display substrate has a pinning layer for fastening the sheet-like member to the light-transmissive substrate.

4. The flat-panel display apparatus according to claim 1, wherein the plurality of holes are formed in the sheet-like member after the sheet-like member has been fastened to the light-transmissive substrate via the pinning layer.

5. The flat-panel display apparatus according to claim 3, wherein the pinning layer is a layer composed mainly of low-fusion-point glass, silica, ceramic, or alumina.

6. The flat-panel display apparatus according to claim 5, wherein the glass that is the main component of the pinning layer is glass whose light-transmitting property is limited to a desired level.

7. The flat-panel display apparatus according to claim 3, wherein the sheet-like member, the light-transmissive substrate, and the pinning layer have approximately the same thermal expansion coefficient.

8. The flat-panel display apparatus according to claim 1, wherein the sheet-like member has an essentially uniform thickness of from 20 to 250 μm.

9. The flat-panel display apparatus according to claim 1, wherein a composition of the sheet-like member includes an alloy containing Fe—Ni as a primary ingredient.

10. The flat-panel display apparatus according to claim 1, wherein each of the plural holes formed in the sheet-like member is formed into an approximately curved sectional shape.

11. The flat-panel display apparatus according to claim 1, wherein a face of the sheet-like member that is directed toward the light-transmissive substrate is approximately black.

12. The flat-panel display apparatus according to claim 1, wherein wall surfaces of fine-structured holes formed in the sheet-like member each have electroconductivity.

13. The flat-panel display apparatus according to claim 1, wherein the fluorescent material existing inside each of the plural holes formed in the sheet-like member takes an approximately U-shaped sectional form.

14. The flat-panel display apparatus according to claim 1, wherein a metal backing to which is applied an acceleration voltage for accelerating the electrons emitted from the cold-cathode elements is disposed on a side of the sheet-like member that faces said rear substrate.

15. The flat-panel display apparatus according to claim 1, wherein recesses for retaining the support structures that maintain a spatial interval between said rear substrate and said display substrate are formed in the sheet-like member.

16. The flat-panel display apparatus according to claim 1, wherein the color filter transmits the rays-of-light of desired colors, emitted from at least one kind of fluorescent material.

17. The flat-panel display apparatus according to claim 2, wherein the dye and the pigment transmit the rays-of-light of desired colors, emitted from at least one kind of fluorescent material.
